(19) United States
(12) Patent Application Publication
(10) Pub. No.: US 2014/0319407 A1
(43) Pub. Date: Oct. 30, 2014

(54) NOVEL USE FOR COMPOSITIONS COMPRISING HFC-134A AND HFO-1234YF AND AN AZEOTROPIC COMPOSITION THEREOF

(71) Applicant: SOLVAY SA, Brussels (BE)

(72) Inventors: Felix Flohr, Hildesheim (DE); Helge Rau, Burgdorf (DE)

(73) Assignee: SOLVAY SA, Brussels (BE)

(21) Appl. No.: 14/359,707

(22) PCT Filed: Nov. 27, 2012
(86) PCT No.: PCT/EP2012/073665

§ 371 Date: May 21, 2014

(30) Foreign Application Priority Data
Dec. 1, 2011 (EP) 11191468.5

(51) Int. Cl. C09K 5/04

(52) U.S. Cl. CPC C09K 5/045
USPC 252/68; 252/67

(57) ABSTRACT

Hydrofluorocarbon compositions which consist of more than 50 to less than 60% wt of HFO-1234yf, and of more than (40) to less than 50 wt % HFC-134a are useful as drop-in substitutes for R-404A, R-507 and R-22. The invention also concerns azeotropic hydrofluorocarbon compositions consisting equal to or more than 56.3 to equal to or less than 58.0 wt of HFO-1234yf, and equal to or more than 42.0 to equal to or less than 43.7% wt of HFC-134a.

This application claims priority to European patent application 11191468.5 filed on 1 Dec. 2011, the whole content of this application being incorporated herein by reference for all purposes.

The present invention relates to a novel use of hydrofluorocarbon compositions, which are suitable, in particular as replacement or drop-in substitute for R-404A (is a HFC “nearly azeotropic” blend of 52 wt % R-143a, 44 wt % R-125, and 4 wt % R-134a), R-507 (is a 50-50 azeotropic blend of R-125 and R-143a) and R-22. The present invention also relates to a specific azeotropic composition.

R-404A and R-507 are useful refrigerants but they have a GWP (Global Warming Potential) of 3.300. R-22 has some impact on the ozone.

US patent application publication 20100047189 describes azeotrope-like compositions of HFO-1234yf and HFC-134a. HFO-1234yf is 2,3,3,3-tetrafluoropropene, CH₂=CF-CF₃. HFC-134a is 1,1,1,2-tetrafluoroethane, CF₃-CH₂F.

The invention makes now available novel uses for refrigerant compositions having zero ozone depletion potential, which are suitable as R-404A and R-507 drop-in substitutes, especially for low-temperature refrigeration applications.

The invention also provides novel compositions which are azeotropes and can be used as R-404A, R-507 and R-22 drop-in substitutes, especially for low- temperature refrigeration applications.

The invention relates in consequence to the use of a hydrofluorocarbon composition which consists of
HFO-1234yf: equal to or more than 50 to equal to or less than 60% wt, and
HFC-134a: equal to or more than 40 to equal to or less than 50 wt % as a drop-in substitute for R-404A, R-507 and R-22. Such a hydrofluorocarbon composition is an azeotrope.

Preferably, the invention relates to the use of a hydrofluorocarbon composition which consists of
HFO-1234yf : equal to or more than 55 to equal to or less than 58% wt, and
HFC-134a : equal to or more than 42 to equal to or less than 45 wt % as a drop-in substitute for R-404A, R-507 and R-22.

More preferably, the invention relates to the use of a hydrofluorocarbon composition which consists of
HFO-1234yf: equal to or more than 56 to equal to or less than 58% wt, and
HFC-134a: equal to or more than 42 to equal to or less than 44 wt % as a drop-in substitute for R-404A, R-507 and R-22.

Still more preferably, the invention relates to the use of a hydrofluorocarbon composition which consists of
HFO-1234yf: equal to or more than 56.5% wt to equal to or less than 58.0% by weight, and
HFC-134a: equal to or more than 42.0 to equal to or less than 43.5% wt wherein the contents of HFO-1234yf and HFC-134a add up to 100% wt, as a drop-in substitute for R-404A, R-507 and R-22.

Especially preferably, the invention relates to the use of a hydrofluorocarbon composition which consists of
HFO-1234yf: equal to or more than 56.5% wt to equal to or less than 56.7% by weight, and
HFC-134a: equal to or more than 43.3 to equal to or less than 43.5% wt wherein the contents of HFO-1234yf and HFC-134a add up to 100% wt, as a drop-in substitute for R-404A, R-507 and R-22.

Most preferably, the invention relates to the use of a hydrofluorocarbon composition which consists of
HFO-1234yf: 56.5% wt, and
HFC-134a: 43.5% wt
   as a drop-in substitute for R-404A, R-507 and R-22.

The use of the hydrofluorocarbon compositions can be performed in a method for cooling an article which comprises condensing the hydrofluorocarbon compositions given above in an apparatus designed for the operation with R-404A or R-507 or R-22 and thereafter, evaporating the composition in the vicinity of the article to be cooled.

The use of the hydrofluorocarbon compositions can alternatively be performed in a method for heating an article which comprises condensing the compositions given above in an apparatus designed for the operation with R-404A or R-507 or R-22 in the vicinity of an article and thereafter, evaporating the hydrofluorocarbon composition.

The methods of cooling and heating can be performed with the hydrofluorocarbon compositions mentioned above in admixture with one or more additives, especially in admixture with at least one lubricant. Suitable lubricants are given below.

The invention relates, in another aspect, to a hydrofluorocarbon composition which consists of
HFO-1234yf: equal to or more than 56.3 to equal to or less than 58.0% wt, and
HFC-134a: equal to or more than 42.0 to equal to or less than 43.7% wt.

A preferred hydrofluorocarbon composition consists of HFO-1234yf: equal to or more than 56.5 to equal to or less than 58.0% wt, and
HFC-134a: equal to or more than 42.0 to equal to or less than 43.5% wt.

An especially preferred hydrofluorocarbon composition consists of
HFO-1234yf: equal to or more than 56.5 to equal to or less than 56.7% wt, and
HFC-134a: equal to or more than 43.3 to equal to or less than 43.5% wt.

A most preferred hydrofluorocarbon composition consists of
HFO-1234yf: 56.5% wt, and
HFC-134a: 43.5% wt.

All the percentages given above are relative to the total weight of the composition.

It has been found, surprisingly, that the hydrofluorocarbon compositions according to the invention when used to replace R-404A and R-507 in existing refrigeration systems offer good oil return characteristics while maintaining good performance, in particular concerning COP and, consequently, energy consumption. The temperature glide of the hydrofluorocarbon compositions according to the invention is zero or practically zero, thereby, when the hydrofluorocarbon compositions, if desired together with at least one additive, especially together with at least one lubricant, are used as refrigerant, the superheat at the end of the evaporation process can be significantly decreased and hence the evaporation temperature lifted. The compositions can be safely used with refrigeration equipment designed for use with R-404A, R-507 and R-22.

The hydrofluorocarbon compositions according to the invention are generally non-flammable, especially when tested in accordance with ASHRAE Standard 34-2007. Non flammability is generally found both in liquid and vapor phases. Preferred hydrofluorocarbon compositions are non flammable both in liquid and vapor phases in case of worst case fractionation scenario, for example according to ASHRAE Standard 34-2007.

The hydrofluorocarbon compositions according to the invention have generally a vapor pressure measured at 55° C. equal or lower than about 25 bars absolute pressure. It has been found that the hydrofluorocarbon compositions having this pressure have particular heat transfer efficiency.

The hydrofluorocarbon compositions according to the invention have generally no temperature glide, or they have a temperature glide, defined as the temperature difference between the bubble point and the dew point at the boiling temperature and corresponding boiling pressure of the composition, which is lower than 0.1° C. For many of the hydrofluorocarbon compositions, it is approximately zero.

Table 1 here after gives the pressure temperature behavior and glide of a hydrofluorocarbon composition which consists of 56.5% wt of HFO-1234yf and 43.5% wt of HFC-134a. The pressure temperature behavior of R-404A and R-507 is given for reference.

TABLE 1

| | | | R1234yf/R134a |
|---|---|---|---|
| | R507 | R404A | 56.5/43.5% |
| | Temperature | Temperature | Temperature |
| Boiling | Glide @ | Glide @ | Glide @ |
| Temperature | Boiling | Boiling | Boiling |
| ° C. | Temperature K | Temperature K | Temperature K |
| −50 | 0.00 | 0.77 | 0.08 |
| −45 | 0.00 | 0.74 | 0.06 |
| −40 | 0.00 | 0.71 | 0.05 |
| −35 | 0.00 | 0.68 | 0.03 |
| −30 | −0.01 | 0.65 | 0.02 |
| −25 | −0.01 | 0.63 | 0.01 |
| −20 | −0.01 | 0.60 | 0.01 |
| −15 | −0.01 | 0.58 | 0.00 |
| −10 | −0.02 | 0.55 | 0.00 |
| −5 | −0.02 | 0.53 | 0.00 |
| 0 | −0.02 | 0.51 | 0.00 |
| 5 | −0.02 | 0.49 | 0.00 |
| 10 | −0.03 | 0.47 | 0.00 |
| 15 | −0.03 | 0.44 | 0.01 |
| 20 | −0.03 | 0.42 | 0.01 |
| 25 | −0.03 | 0.40 | 0.02 |
| 30 | −0.03 | 0.38 | 0.02 |
| 35 | −0.04 | 0.36 | 0.02 |
| 40 | −0.04 | 0.33 | 0.03 |
| 45 | −0.04 | 0.31 | 0.03 |
| 50 | −0.03 | 0.28 | 0.03 |
| 55 | −0.03 | 0.25 | 0.03 |
| 60 | −0.03 | 0.21 | 0.03 |
| 65 | −0.02 | 0.17 | 0.02 |

The hydrofluorocarbon compositions according to the invention may be combined for example, with additives or auxiliaries used in refrigeration such as in particular a lubricant to provide refrigerant compositions. Suitable lubricants include in particular those which are suitable for use with R-404A, R-507 or R-22. Examples of lubricants which can suitably be combined with the hydrofluorocarbon compositions according to the invention are selected from mineral oil, for example napthtenic mineral oils, alkylbenzene oils lubricants, and polyol ester oils or mixtures thereof.

When the hydrofluorocarbon compositions of HFO-1234yf and HFC-134a according to the invention are combined with an additive, in particular a lubricant, as described here before, the resulting composition is a refrigerant composition; the hydrofluorocarbon compositions further containing an additive, especially the lubricant, i.e. the resulting refrigerant compositions, include the hydrofluorocarbon composition and the additive—which preferably is a lubricant —such that the weight ratio of hydrofluorocarbon composition/additive is generally from equal to or greater than 99:1 to equal to or less than 80:20 (weight/weight) preferably from equal to or greater than 98.5:1.5 to equal to or less than 95:5 (weight/weight).

The invention relates also to the refrigerant compositions which are a combination of the hydrofluorocarbon compositions according to the invention with an additive, especially a lubricant, as described here before.

The invention relates also to a refrigeration apparatus which is designed for use with R-404A, R-507 or R-22 and which contains a refrigerant composition comprising at least the following components:
a hydrofluorocarbon composition which consists of equal to or more than 50 to equal to or less than 60% wt of HFO-1234yf, and equal to or more than 40 to equal to or less than 50 wt % of HFC-134a,
a lubricant, the weight ratio of hydrofluorocarbon composition/lubricant being generally from equal to or greater than 99:1 to equal to or less than 80:20 (weight/weight) preferably from equal to or greater than 98.5:1.5 to equal to or less than 95:5 (weight/weight)
optionally other additives, wherein the components add up to 100% wt.

A preferred apparatus which is designed for use with R-404A, R-507 or R-22 contains a refrigerant composition comprising a hydrofluorocarbon composition which consists of
equal to or more than 55 to equal to or less than 58% wt HFO-1234yf and equal to or more than 42 to equal to or less than 45 wt % HFC-134a and wherein the components of the refrigerant composition add up to 100% wt.

A more preferred apparatus which is designed for use with R-404A or R-507 or R-22 contains a refrigerant composition comprising a hydrofluorocarbon composition which consists of
equal to or more than 56 to equal to or less than 58% wt HFO-1234yf and more than 42 to less than 44 wt % HFC-134a and wherein the components of the refrigerant composition add up to 100% wt.

An very preferred apparatus which is designed for use with R-404A or R-507 or R-22 contains a refrigerant composition which comprises a hydrofluorocarbon composition which consists of equal to or more than 56.3 to equal to less than 58% wt HFO-1234yf, and
equal to or more than 42 to equal to or less than 43.7% wt HFC-134a, and wherein the components of the refrigerant composition add up to 100% wt.

An still more preferred apparatus contains a refrigerant composition which comprises a hydrofluorocarbon composition which consists of equal to or more than56.5 to equal to less than 58% wt HFO-1234yf, and equal to or more than 42 to equal to or less than 43.5% wt HFC-134a, and wherein the components of the refrigerant composition add up to 100% wt.

A especially preferred apparatus which is designed for use with R-404A or R-507 or R-22 contains a refrigerant composition which comprises a hydrofluorocarbon composition which consists of equal to or more than56.5 to equal to less than 56.7% wt HFO-1234yf, and equal to or more than 43.3 to equal to or less than 43.5% wt HFC-134a, and wherein the components of the refrigerant composition add up to 100% wt.

A most preferred apparatus which is designed for use with R-404A or R-507 or R-22 contains a refrigerant composition which comprises a hydrofluorocarbon composition which consists of 56.5% wt HFO-1234yf and 43.5% wt HFC-134a wherein the components of the refrigerant composition add up to 100% wt.

The apparatus which is designed for use with R-404A or R-507 or R-22 thus contains a refrigerant composition which also contains a lubricant. Lubricants are mentioned above; preferred lubricants are selected from the group consisting of mineral oil, alkylbenzene oil and polyol ester oils or mixtures thereof.

The refrigeration apparatus which is designed for use with R-404A or R-507 or R-22 according to the invention is preferably suitable for providing low-temperature refrigeration.

“Low temperature refrigeration” is understood to denote in particular cooling a body to be cooled to a temperature of from −45° C. to −20° C. The refrigerant compositions according to the invention and the refrigeration apparatus according to the invention are particularly suitable for cooling a body to be cooled to a temperature of from −35° C. to −20° C.

The refrigerant compositions according to the invention and the refrigeration apparatus according to the invention are also suitable for “normal refrigeration”, understood to denote in particular cooling a body to be cooled to a temperature of from greater than −20° C. to +5° C.

In a particular embodiment, the refrigeration apparatus according to the invention has been used with R-404A or R-507 or R-22, and R-404A or R-507 or R-22 have been replaced by the hydrofluorocarbon compositions according to the invention. In a particular aspect of the refrigeration apparatus according to this embodiment, a lubricant, in particular as described above was used with R-404A or R-507 or R-22, and said lubricant has been at least partially kept in the apparatus for use with the composition according to the invention.

The hydrofluorocarbon compositions according to the invention are preferably used as replacement for R-404A or R-507 or R-22, in particular as drop-in replacement for R-404A or R-507 or R-22.

Should the disclosure of any patents, patent applications, and publications which are incorporated herein by reference conflict with the description of the present application to the extent that it may render a term unclear, the present description shall take precedence.

The examples here after are intended to illustrate the invention without however limiting it.

### EXAMPLE 1

### Refrigeration with a Composition According to the Invention

In an apparatus working with simple refrigeration cycle containing a composition which consists of 56.5% wt HFO-1234yf and 43.5% wt HFC-134a (hereafter also denoted as “composition”), evaporation of the refrigerant composition is carried out at −30° C. and condensation is carried out at variable temperatures (30/35/40/45° C.). Superheat is 5K and subcooling is 2K. The compressor efficiency at the different temperatures is given in the table 2 here after.

### EXAMPLE 2 (Comparison)

### Refrigeration with Prior Art Refrigerants

Following the same procedure as in example 1, the volumetric cooling capacity of R-404A and R-507 at different temperatures are given for comparison.

The results of examples 1 and 2 are shown in Table 2. It is apparent that the composition according to the invention comes the closest to the volumetric cooling capacity of R-404A and R-507 and is superior to the prior art non-ozone depleting R22 replacements.

TABLE 2

| | | | | | Isent. | | |
|---|---|---|---|---|---|---|---|
| | t. | t | p | Ratio | Efficien- | | |
| Refrig- | evap., | cond. | evap., | pcond./ | cy Com- | | Qvol, |
| erant | ° C. | ° C. | bar | p evap. | pressor | COP | kJ/m³ |
| R404A | −30 | 30 | 2.02 | 7.06 | 0.82 | 2.28 | 1158.36 |
| | −30 | 35 | 2.02 | 8.01 | 0.82 | 2.00 | 1077.91 |
| | −30 | 40 | 2.02 | 9.05 | 0.82 | 1.74 | 995.15 |
| | −30 | 45 | 2.02 | 10.18 | 0.82 | 1.51 | 909.65 |
| R507 | −30 | 30 | 2.13 | 6.86 | 0.82 | 2.29 | 1201.24 |
| | −30 | 35 | 2.13 | 7.78 | 0.82 | 2.00 | 1115.44 |
| | −30 | 40 | 2.13 | 8.78 | 0.82 | 1.74 | 1027.10 |
| | −30 | 45 | 2.13 | 9.89 | 0.82 | 1.50 | 935.71 |
| Compo- | −30 | 30 | 1.09 | 8.07 | 0.82 | 2.42 | 714.81 |
| sition | −30 | 35 | 1.09 | 9.23 | 0.82 | 2.14 | 671.37 |
| | −30 | 40 | 1.09 | 10.52 | 0.82 | 1.88 | 627.15 |
| | −30 | 45 | 1.09 | 11.93 | 0.82 | 1.66 | 582.05 |

T. evap. Evaporation Temperature
T cond. Condensation Temperature
p evap. Evaporation pressure
p cond. Condensing pressure
COP Coefficient of Performance
Qvol. Volumetric Capacity

It can be seen from table 2 that the coefficient of performance (COP) of the azeotropic mixture is comparably high.

### EXAMPLE 3

### Substitution of Refrigerant R-404A

A refrigeration apparatus is operated using R-404A as a hydrofluorocarbon composition and using a mineral oil as lubricant. To substitute R-404A by the azeotropic hydrofluorocarbon composition of the invention, power of the refrigeration apparatus is switched off. The R-404A in the apparatus is recovered. The mineral oil is checked, and if necessary, it is removed. In this case, its amount is determined and compared with the recommended oil charge to determine approximately the quantity of oil left in the apparatus. The spent oil is replaced by the appropriate amount of fresh oil. If desired, the apparatus is run while performing the oil change procedure until the desired level of spent oil is achieved. A 24-hour leak test is performed by applying dry nitrogen. If the pressure after 24 hours has an acceptable residual level, vacuum is applied to the apparatus, and after having evacuated low boiling constituents in the apparatus, the appropriate amount of the azeotropic hydrofluorocarbon composition of HFC-1234yf and HFC-134a is filled into the apparatus, preferably in liquid form. The apparatus is run, the level of refrigerant and mineral oil is checked, and, if necessary, refrigerant and/or oil is added. A label is added to the apparatus.

1. A drop-in substitute for R-404A and R-507 and R-22, the substitute comprising Use of a hydrofluorocarbon composition which consists of equal to or more than 50 to equal to or less than 60% wt of HFO-1234yf and equal to or more than 40 to equal to or less than 50 wt % HFC-134a.

2. The use of drop-in substitute according to claim 1, wherein the hydrofluorocarbon composition consists of equal to or more than56.3% wt to equal to or less than 56.7% by weight of HFO-1234yf and equal to or more than 43.3% by weight to equal to or less than 43.7% wt of HFC-134a, wherein the contents of HFO-1234yf and HFC-134a add up to 100% wt.

3. The use of drop-in substitute according to claim 2, wherein the hydrofluorocarbon composition consists of 56.5 wt HFO-1234yf and 43.5% wt of HFC-134a.

4. The use of any one of drop-in substitute according to claim 1 wherein the hydrofluorocarbon composition is in admixture with a lubricant.

5. The drop-in substitute according to claim 4, wherein the lubricant is selected from the group consisting of mineral oil, alkylbenzene oil and polyol ester oil.

6. The use of drop-in substitute according to claim 4 wherein the weight ratio hydrofluorocarbon composition/lubricant is from 99:1 to 80:20 (weight/weight).

7. A hydrofluorocarbon composition which consists of equal to or more than 56.3 to equal to or less than 58% wt of HFO-1234yf and equal to or more than 42 to equal to or less than 43.7 wt % HFC-134a.

8. The hydrofluorocarbon composition according to claim 7 which consists of equal to or more than 56.5 to equal to or less than 58% wt of HFO-1234yf and equal to or more than 42 to equal to or less than 43.5 wt % HFC-134a.

9. The hydrofluorocarbon composition of claim 8, consisting of 56.5% wt HFO-1234yf and 43.5% wt of HFC-134a.

10. The composition of claim 8 further comprising an additive.

11. The composition of claim 16, wherein the lubricant is selected from mineral oil and alkylbenzene oil and polyol ester oil.

12. The composition of claim 16 wherein the weight ratio hydrofluorocarbon composition/lubricant is from 99:1 to 80:20 (weight/weight).

13. A refrigeration apparatus designed for operation with R-404A or R-507 or R-22, the apparatus containing a hydrofluorocarbon composition which consists of equal to or more than 50 to equal to or less than 60% wt of HFO-1234yf and equal to or more than 40 to equal to or less than 50 wt % HFC-134a.

14. The refrigeration apparatus according to claim 13 wherein the apparatus is suitable for providing low-temperature refrigeration.

15. The drop-in substitute according to claim 1, wherein the hydrofluorocarbon composition consists of equal to or more than 55 to equal to or less than 58% wt of HFO-1234yf and equal to or more than 42 to equal to or less than 45 wt % HFC-134a.

16. The composition according to claim 10, wherein the additive is a lubricant.

17. The refrigeration apparatus according to claim 13, wherein the hydrofluorocarbon composition consists of equal to or more than 55 to equal to or less than 58% wt of HFO-1234yf and equal to or more than 42 to equal to or less than 45 wt % HFC-134a.
